(19) United States
(12) Patent Application Publication
(10) Pub. No.: US 2013/0219794 A1
(43) Pub. Date: Aug. 29, 2013

(54) WINDOW REGULATOR

(71) Applicants: Teruyuki Nakamura, Sakura-shi (JP); Tsutomu Iwaya, Sakura-shi (JP); Toshiyuki Kanai, Sakura-shi (JP); So Takakura, Sakura-shi (JP)

(72) Inventors: Teruyuki Nakamura, Sakura-shi (JP); Tsutomu Iwaya, Sakura-shi (JP); Toshiyuki Kanai, Sakura-shi (JP); So Takakura, Sakura-shi (JP)

(73) Assignee: YACHIYO INDUSTRY CO., LTD., Sayama-shi, Saitama (JP)

(21) Appl. No.: 13/882,232

(22) PCT Filed: Sep. 27, 2011
(86) PCT No.: PCT/JP2011/072050

§ 371 Date: Apr. 29, 2013

(30) Foreign Application Priority Data
Nov. 8, 2010 (JP) 2010-249849
Nov. 8, 2010 (JP) 2010-249850
Nov. 15, 2010 (JP) 2010-254866
Aug. 1, 2011 (JP) 2011-168403

(51) Int. Cl. E05F 15/16

(52) U.S. Cl. CPC E05F 15/1692
USPC 49/350

(57) ABSTRACT

A window regulator includes: a drive gear attached to a drive motor; an open-ended pliable elongate push-pull member that meshes with the drive gear and is push-pulled by the two-way rotation of the drive gear; and a career connected to one end of the elongate push-pull member as well as a window glass, wherein, as viewed from a direction substantially perpendicular to the plate surface of the window glass, a drive route of the elongate push-pull member from an meshing portion between the drive gear and the elongate push-pull member to a mounting portion of the career is formed in a straight line, while at least a part of an idle route from the meshing portion to the other end of the elongate member is formed in a curved shape.

### CROSS REFERENCE TO RELATED APPLICATION

The present application claims benefit of the filing date of PCT Application No. PCT/JP2011/072050 filed on Sep. 27, 2011 which is incorporated herein by reference.

### TECHNICAL FIELD

The present invention relates to a window regulator for lifting and lowering a window glass of a vehicle.

### BACKGROUND OF INVENTION

Each of Japanese Laid-Open Patent Application No. 559-52078A and Japanese Patent No. 3215928B describes a conventional example of a window regulator including a drive gear attached to a drive motor and an open-ended pliable elongate push-pull member that meshes with the drive gear and is push-pulled by the two-way rotation of the drive gear, and structured to lift and lower a window glass via a carrier connected to the elongate push-pull member.

A technique disclosed in Japanese Laid-Open Patent Application No. 559-52078A is related to a structure of an elongate push-pull member itself, wherein the elongate push-pull member is constituted by coupling and fixing a reinforcing chain to a pliable elongate material.

A technique disclosed in Japanese Patent No. 3215928B is related to a mounting structure of a window regulator, wherein the window regulator is mounted on a side beam fixed to an outer door panel, together with a door hinge and a door lock.

Further, a window regulator is proposed to use a tape, having holes at regular intervals, as an elongate push-pull member, and a guide rail provided with a sprocket, having a teeth portion for engaging with the tape holes, at the upper and lower ends, wherein both sprockets are encircled by the tape and one of the sprockets is rotationally driven by a motor, thereby lifting and lowering a window glass held by a career (see Japanese Patent No. 3720500B and Japanese Patent No. 3616246B).

### SUMMARY OF INVENTION

### Problems to be Solved

The elongate push-pull member is required to have the ability to efficiently convert the rotational force of the drive motor into substantially rectilinear moving force of the carrier and transmit the converted force to the carrier. It is necessary to arrange the elongate push-pull member compactly when laid out in a limited space of a door panel while suppressing a decrease in the power transmission efficiency, as the elongate push-pull member is a long material.

The present invention is invented to solve the aforesaid problems and intended to provide a window regulator that enables reduction of the power transmission loss at the elongate push-pull member, as well as compactness of the layout space.

Further, it is preferable that the engaging portion of the elongate push-pull member with the carrier has a simple and compact structure so as to move on a guide rail.

The present invention is invented to solve the aforesaid problem also and intended to provide a window regulator that enables a simple and compact structure of the engaging portion of the elongate push-pull member and the carrier.

In addition, as a window regulator of the prior art needs to have a predetermined tension imparted to the wire or the tape and the tension needs to be imparted again when the wire or the tape is stretched, it is troublesome to initialize and maintain such a window regulator. Moreover, the invention described in Japanese Patent No. 3720500B and Japanese Patent No. 3616246B tends to have dirt and dust adhered to the surface of the tape, thereby inhibiting a smooth engagement between the tape through-holes and the sprocket teeth, thus likely causing an increase of a driving resistance and/or a generation of an abnormal noise.

The present invention is invented to further solve the aforesaid problem and intended to provide a window regulator which is easy to handle by eliminating the need for the tension setting of the transmission means of the motor driving force, as well as insusceptible to adhesion of dirt or the like. Means for solving Problems

In order to solve the aforesaid problems, the present invention provides a window regulator including a drive gear that is attached to a drive motor, an open-ended pliable elongate push-pull member that meshes with the drive gear and is push-pulled by the two-way rotation of the drive gear, and a career that is connected to one end of the elongate push-pull member as well as a window glass, wherein, as viewed from a direction substantially perpendicular to the plate surface of the window glass, a drive route of the elongate push-pull member from an meshing portion between the drive gear and the elongate push-pull member to a mounting portion of the career is formed in a straight line, while at least a part of an idle route for retracting an extra length of the elongate push-pull member from the meshing portion to the other end of the elongate member is formed in a curved shape.

According to the window regulator, since the drive route of the elongate push-pull member is formed in a straight line when viewed from a direction substantially perpendicular to the plate surface of the window glass, a curved portion no longer exists at the elongate push-pull member on the drive route. Therefore, the bending stress does not occur, hence the transmission loss of the power by the elongate push-pull member is reduced, thus the rotational force of the drive motor is efficiently converted into rectilinear moving force of the carrier and the converted force is transmitted to the carrier. On the other hand, at least a part of an idle route is formed in a curved shape again as viewed from a direction substantially perpendicular to the plate surface of the window glass, thus the elongate push-pull member can be laid out compactly in a limited space such as a side door of a vehicle.

In addition, the present invention is characterized that the drive route is formed upward from the meshing portion, while the idle route has a curved portion which is convex downward and an end of the idle route is positioned above the meshing portion.

If the drive route is formed downward from the meshing portion, such a structure is required that does not interfere with the drive motor in the connecting portion of the career and the window glass, since the drive motor is located at the upper side, and further, the position of the center of gravity of the window regulator tends to be high. On the contrary, by forming the drive route upward from the meshing portion, the drive motor is meant to be located at the lower portion of the window regulator, thus the connecting portion of the carrier and the window glass can have a simple structure, and further, the position of the center of gravity of the window regulator is low and the window regulator is suitable for the side door of the vehicle that requires low center of gravity.

Then, by providing a curved portion, which is convex downward, on the idle route and positioning the end of the idle route above the meshing portion, it is possible to more compactly retract and house the elongate push-pull member by folding it upward.

Moreover, the present invention further includes a guide rail that guides the elongate push-pull member and the carrier on the drive route, wherein the guide rail includes a rectangular frame portion, having an opening for inserting the carrier and constituting a guide groove for the elongate push-pull member, and the engaging portion between the elongate push-pull member and the career is laid out inside the rectangular frame portion.

According to the above window regulator, the structure of the engaging portion between the elongate push-pull member and the carrier is simple and compact, and it is possible to save space around the guide rail since the engaging portion does not move outside of the guide rail, thus providing a compact window regulator.

Further, the present invention includes an elongate push-pull member that is composed of a rack belt, wherein an engaging portion between the rack belt and the carrier is constituted with an overlapping portion between a thin belt portion of the rack belt, where the thin belt portion is formed by cutting out a surface having the rack teeth and formed with engaging holes, and a thin plate portion of the career, where the thin plate portion is formed with engaging projections, accompanied with an engagement between the engaging holes and the engaging projections.

According to the above window regulator, the engaging portion has an inexpensive and easy-assembling structure.

Furthermore, the present invention is characterized that the forming range of the engaging portion is in a position overlapping with the forming range of a connecting portion between the carrier and the window glass, with respect to a direction along the drive route.

According to the above window regulator, it is possible to attain a compact career, because the forming range of the engaging portion and the forming range of the connecting portion are in an overlapping position with respect to the direction along the drive route, and also to increase the rigidity of the carrier, because the generation of stresses between the engaging portion and the connecting portion of the carrier is reduced.

Still further, the present invention is characterized that the elongate push-pull member is composed of a rack belt that is laid out inside the rectangular frame portion so that a surface formed with the rack teeth faces the opposite side from the opening.

According to the above window regulator, the initial configuration of the rack belt is easy since it is not necessary to be formed into an endless loop having a predetermined tension applied, and the maintenance is also easy since it is not necessary to take countermeasures against the stretch even when the rack belt is stretched. Besides, it is possible to reduce adhesion of dirt entering from the opening to the rack teeth since the surface formed with the rack teeth faces the opposite side from the opening of the guide rail. Therefore, the rack teeth and the drive gear engage smoothly, thereby preventing an increase of the driving resistance and a generation of the abnormal noise.

### Effects of Invention

According to the present invention, it is possible to attain both of reduction of the power transmission loss at the elongate push-pull member and compactness of the layout space.

Further, according to the present invention, the structure of the engaging portion between the elongate push-pull member and the carrier is simple and compact, and it is possible to save space around the guide rail since the engaging portion does not move outside of the guide rail, thus providing a compact window regulator.

Furthermore, according to the present invention, the rack belt is free from a tension setting and insusceptible to adhesion of dirt or the like to the rack teeth since the surface formed with the rack teeth faces the opposite side from the opening of the guide rail.

### BRIEF DESCRIPTION OF DRAWINGS

FIG. 1 is a perspective view showing an embodiment in which a window regulator according to the present invention is applied to a side door of a vehicle.

FIG. 2 is a schematic side view showing a drive route and an idle route of the elongate push-pull member.

FIG. 3 is a perspective view of a window regulator according to the present invention.

FIG. 4 is an exploded perspective view of Portion A in FIG. 3.

FIG. 5 is an exploded perspective view of Portion B in FIG. 3.

FIG. 6 is a cross-sectional view at line I-I in FIG. 3.

FIG. 7 is a cross-sectional view at line II-II in FIG. 3.

FIG. 8A is a cross-sectional view at line III-III in FIG. 3 and FIG. 8B is a cross-sectional view at line IV-IV in FIG. 8A.

FIG. 9 is a cross-sectional view at line V-V in FIG. 3.

FIG. 10 is a cross-sectional view at line VI-VI in FIG. 3.

FIG. 11A is a cross-sectional view at line VII-VII in FIG. 3 and FIG. 11B is a cross-sectional view at line VIII-VIII in FIG. 11A.

FIG. 12A and FIG. 12B are explanatory diagrams showing a holding means of the track of a geared wire on the idle route when the elongate push-pull member is composed of the geared wire.

FIG. 13 is a diagram showing a modification of the present invention and an exploded perspective view around the carrier.

FIG. 14A is a partial side view of a modification of the carrier shown in FIG. 13, and FIG. 14B is a partial side view of the carrier shown in FIG. 4.

### EMBODIMENT OF INVENTION

An embodiment will be described hereinafter, wherein a window regulator is applied to a side door of a vehicle. In the following description, the direction P shall refer to a direction along the plate surface of the window glass in a plan view (that is, longitudinal direction of the vehicle), and the direction Q shall refer to a direction substantially perpendicular to the plate surface of the window glass (that is, width direction of the vehicle).

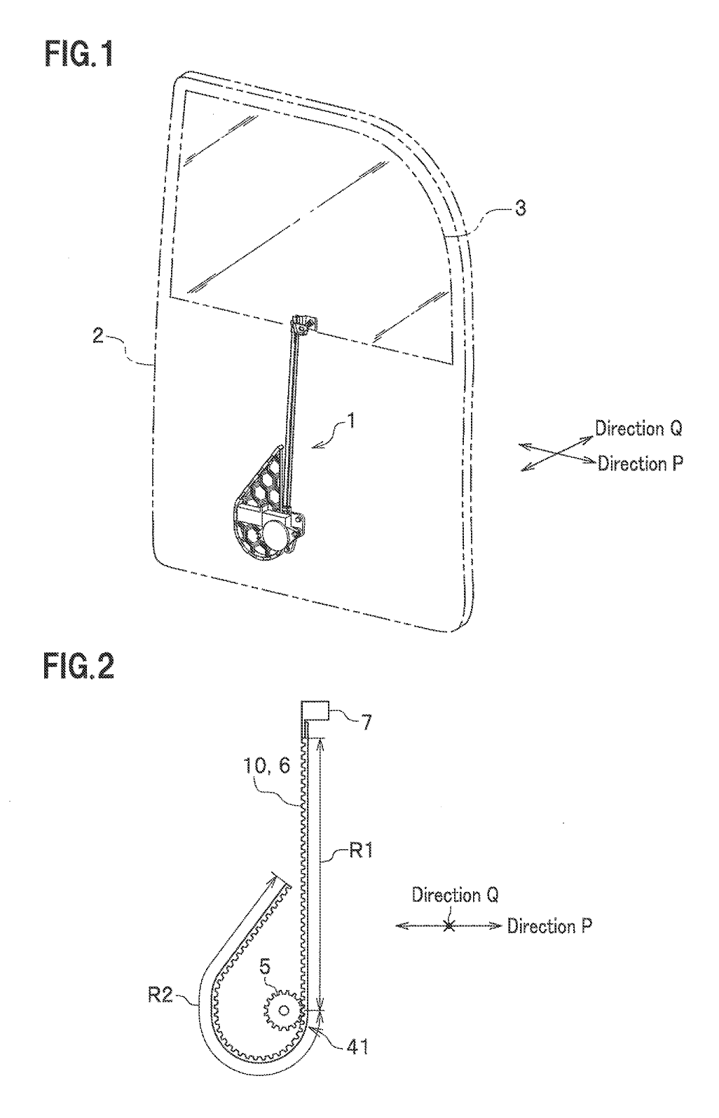

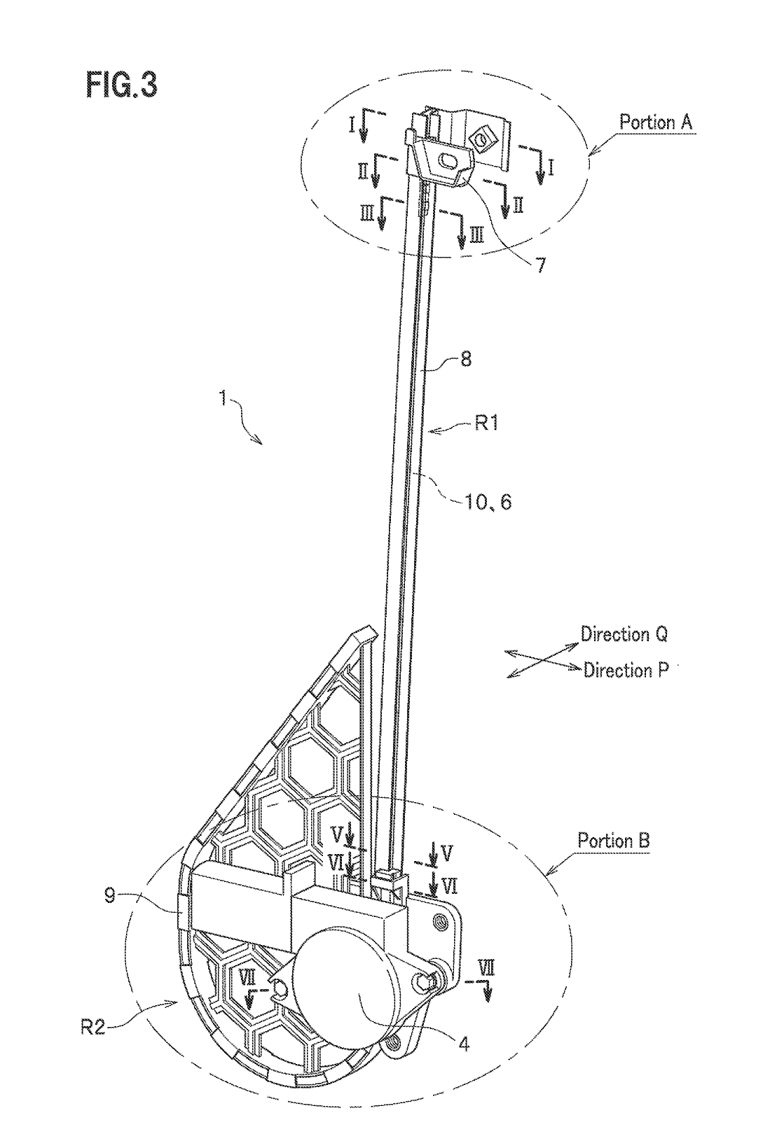

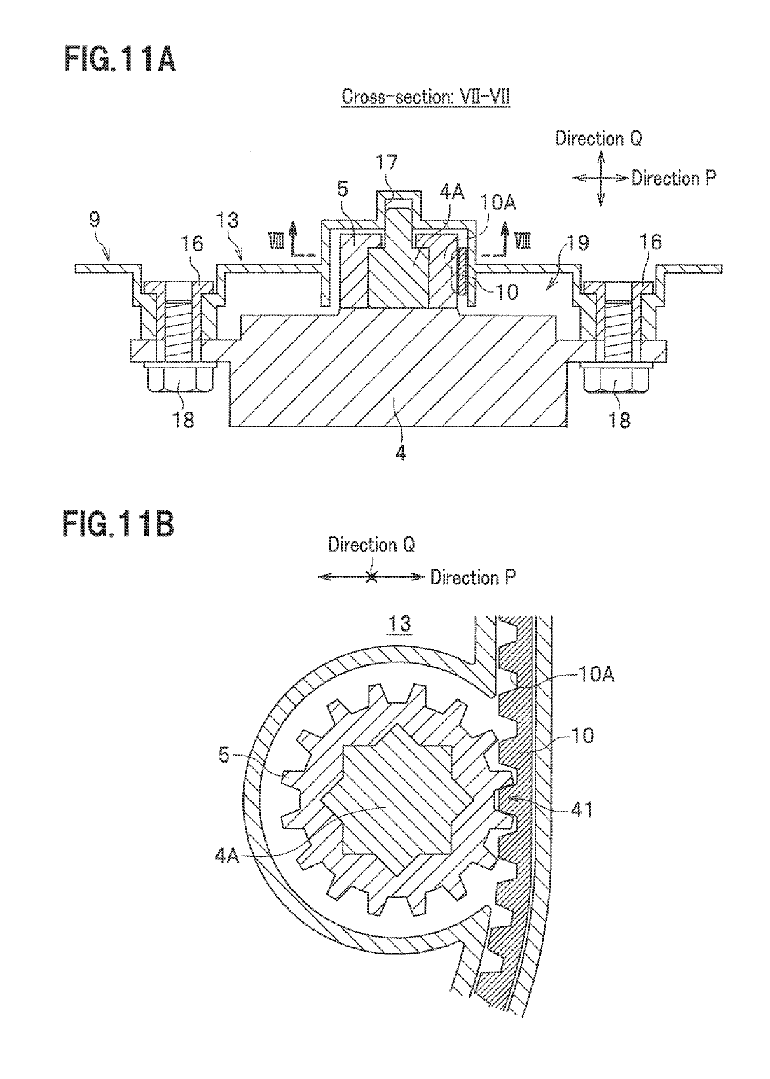

As shown in FIG. 1, the window regulator 1 of the present invention is built at lower inside of the side door 2 of the vehicle for lifting and lowering the window glass 3. As shown in FIG. 3, the window regulator 1 includes as main components: a drive motor 4; a drive gear 5 attached to the output shaft of the driving motor 4 (FIGS. 11A and 11B); an open-ended (i.e., having one end and the other end) pliable elongate push-pull member 6 that meshes with the drive gear 5 and is push-pulled by the two-way rotation of the drive gear 5; a carrier 7 connected to the window glass 3 as well as one end of the elongate push-pull member 6; a guide rail 8 that guides the elongate push-pull member 6 and the carrier 7 on the drive route R1; and a frame 9 that is integrally formed with a means for fixing and supporting the drive motor 4, a means for fixing and supporting the guide rail 8, a means for supporting a track of the elongate push-pull member 6 on the idle route R2, and a means for attaching thereof to the object (the side door 2).

In FIG. 2, the drive route R1 is a route for converting a rotational force of the drive gear 5 to a substantially linear movement force of the carrier 7 and transmitting the converted force to the carrier 7, and is a route for the elongate push-pull member 6 to move from the meshing portion 41 between the drive gear 5 and the elongate push-pull member 6 to the connecting portion with the carrier 7. The idle route R2 is a route to retract the extra length of the elongate push-pull member 6 when the carrier 7 is lowered. As viewed from the direction Q, the drive route R1 is formed in a straight line, while at least a part of the idle route R2 is formed in a curved shape.

### Elongate Push-Pull Member 6 and Carrier 7

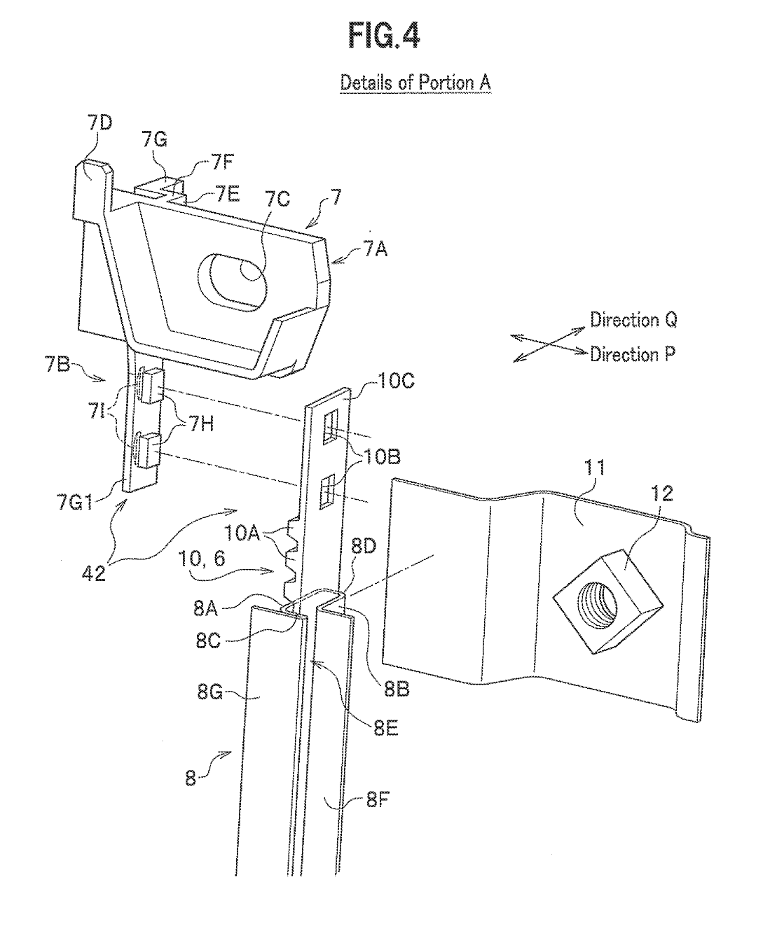

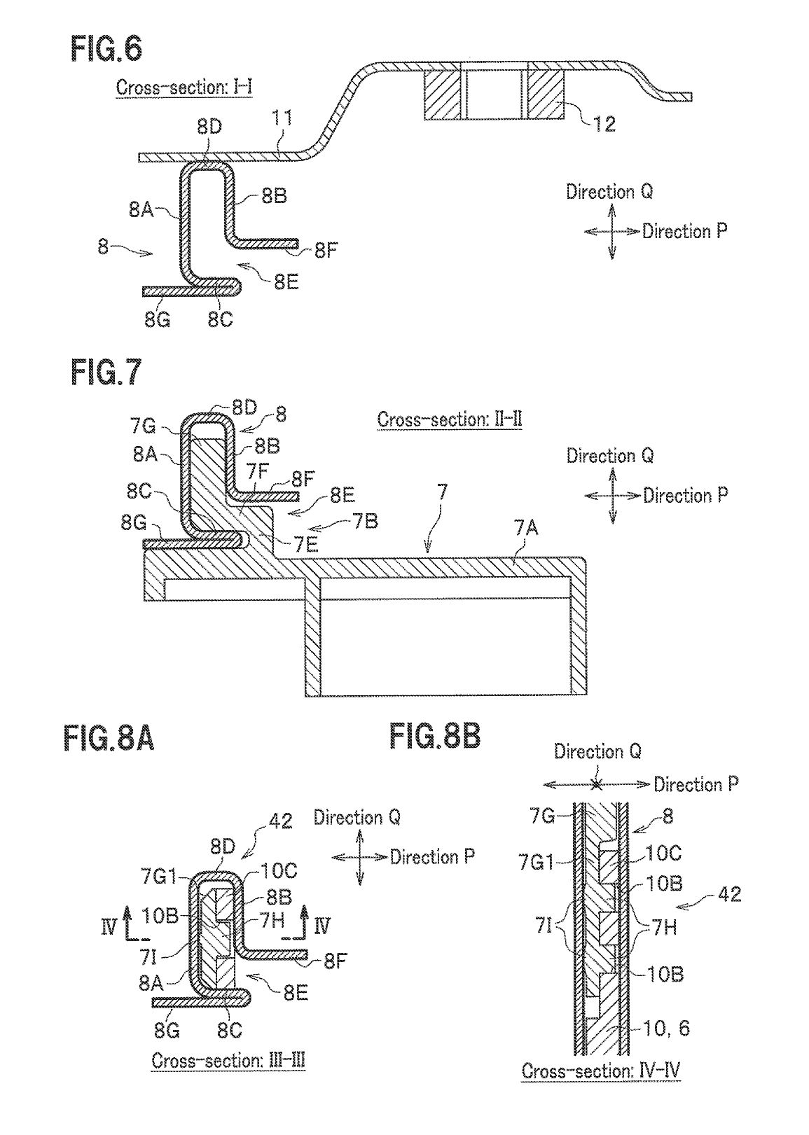

The elongate push-pull member 6 and the carrier 7 will be described by referring to FIG. 4 and FIGS. 6 to 8. The elongate push-pull member 6 according to the present embodiment is composed of a rack belt 10 having rack teeth 10A formed on one side. Therefore, the drive gear 5 meshing with the rack belt 10 is a pinion gear. The rack belt 10 is made of synthetic resin, for example. The rack belt 10 is laid out so that the rack teeth 10A face toward the direction P.

The carrier 7 includes a glass connecting portion 7A that is formed as a plate surface along the direction P and connected to the lower part of the window glass 3, and a belt coupling portion 7B that is protruded on one surface of the glass connecting portion 7A and connected to one end of the rack belt 10. The glass connecting portion 7A is in a substantially rectangular shape as viewed from the direction Q, and formed with a mounting hole 7C, through which a bolt (not shown) for fixing the window glass 3 is passed. In addition, an anti-drop wall 7D for the window glass 3 is protruded on the other side of the glass connecting portion 7A.

A belt coupling portion 7B includes, in plan view as shown in FIG. 7, a base portion 7E that stands perpendicular to one surface of the glass connecting portion 7A, an intermediate portion 7F that extends in parallel to the plate surface of the glass connecting portion 7A from a front end of the base 7E, and a sliding portion 7G that extends from a front end of the intermediate portion 7F to a direction apart from the one surface of the glass connecting portion 7A, and has a crank shape. While the lower ends of the base portion 7E and the intermediate portion 7F extend down to the lower edge of the glass connecting portion 7A, the sliding portion 7G extends downward further than the lower edge of the glass connecting portion 7A, as shown in FIG. 4. The sliding portion 7G that extends below the lower edge of the glass connecting portion 7A is formed as a thin plate portion 7G1, having an upper and lower pair of cuboid engaging projections 7H protruded from one side thereof, and arc-shaped resilient projections 71 arranged vertically on the other side thereof directly behind the protruding positions of the respective engaging projections 7H.

As shown in FIG. 4 and FIG. 8B, one surface of the rack belt 10 on which the rack teeth 10A are formed is cut out at one end by the amount of depth comparable to the thickness of the thin plate portion 7G1 of the belt coupling portion 7B, and an upper and lower pair of a rectangular engaging holes 10B are punched on a thin belt portion 10C which became thinner by the cutout. The belt coupling portion 7B is connected to the rack belt 10 by overlapping the thin plate portion 7G1 with the thin belt portion 10C of the rack belt 10 and engaging each of the engaging projections 7H with each of the engaging holes 10B, respectively. In this way, an engaging portion 42 of the rack belt 10 and the carrier 7 is laid out inside of the guide rail 8, therefore the engaging portion 42 does not come off from inside of the guide rail 8 unless the window regulator 1 is disassembled.

### Guide Rail 8

The guide rail 8 will be described with reference to FIG. 4 and FIGS. 6 to 8. The guide rail 8 is an elongate material of a constant cross-section extended almost vertically, exhibiting a gentle curve in accordance with the curved shape of the window glass 3 as viewed from the direction P, while exhibiting a straight line shape as viewed from the direction Q. The guide rail 8 has a rectangular frame portion that is longitudinal in the direction Q, so as to guide the four sides of the rack belt 10 in a flat cross-sectional shape, as shown in FIG. 8. The rectangular frame portion includes: a first frame surface 8A that faces a surface of the rack belt 10 having the rack teeth 10A; a second frame surface 8B that faces opposite to the surface of the rack belt 10 having the rack teeth 10A (the back side of the rack belt 10); and a third and fourth frame surfaces 8C, 8D that face each side surface of the rack belt 10, and the inner space surrounded by the rectangular frame provides a guide groove for the rack belt 10. In other words, the engaging portion 42 between the rack belt 10 and the carrier 7 is laid out in the guide groove for the rack belt 10 on the guide rail 8. The third frame surface 8C is the surface that faces the one surface of the glass connecting portion 7A of the carrier 7. An opening 8E is formed for passing the belt coupling portion 7B of the carrier 7 (the intermediate portion 7F) on the second frame surface 8B at a part closer to the third frame surface 8C, and a first flange surface 8F is projected along the direction P from the edge of the opening 8E closer to the fourth frame surface 8D. In addition, a second flange surface 8G is projected in the opposite direction to the first flange surface 8F in a manner that is substantially extended from the third frame surface 8C.

The guide rail 8 is a formed by sheet metal working, for example, and formed integrally by bending in the order of the first flange surface 8F, the second frame surface 8B, the fourth frame surface 8D, the first frame surface 8A, the third frame surface 8C and the second flange surface 8G. The second flange surface 8G is formed by folding back the third frame surface 8C. Of course, the guide rail 8 may be composed of an extruded product.

A fixing bracket 11 for fixing the guide rail 8 to the side door 2 is attached to the fourth frame surface 8D at the top of the guide rail 8 by welding or the like. The fixing bracket 11 is formed as a plate surface substantially along the direction P. A nut 12 in which a bolt (not shown) is screwed for fastening the guide rail 8 to the side door 2 is attached to the fixing bracket 11.

### Frame 9

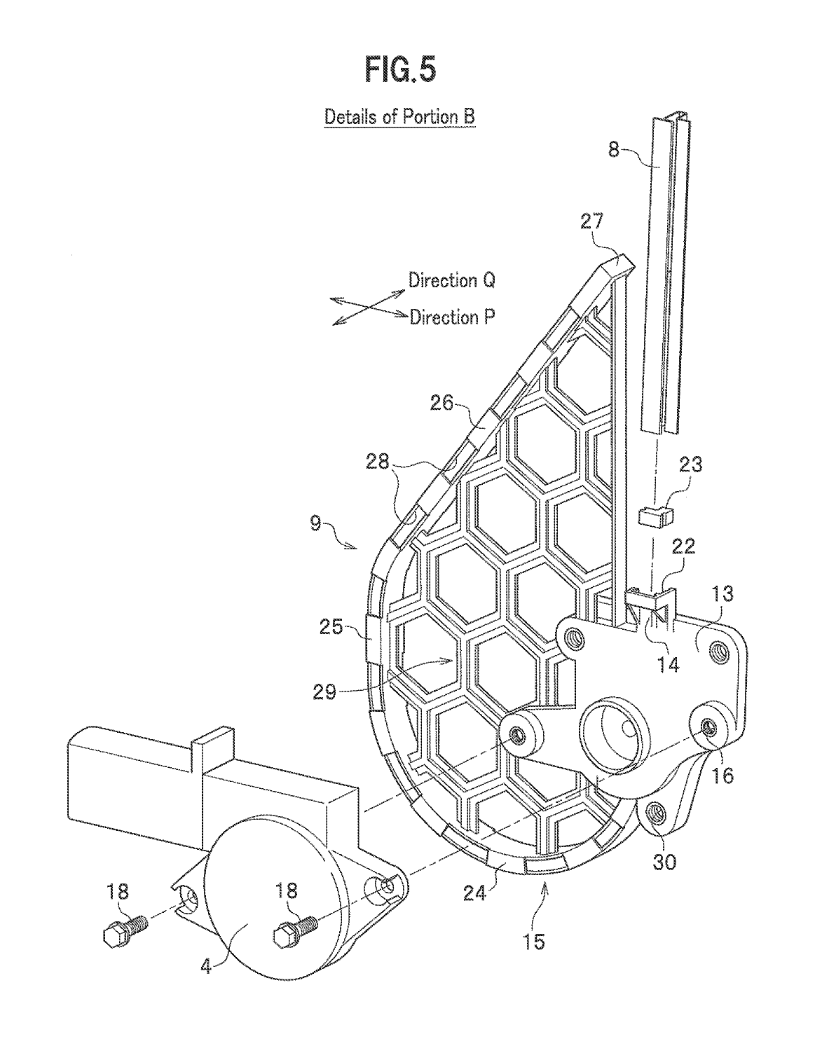

The frame 9 will be described with reference to FIG. 5 and FIGS. 9 to 11. The frame 9 includes: a motor fixing portion 13 that fixes and supports the drive motor 4; a guide rail fixing portion 14 that fixes and supports the lower end of the guide rail 8; and an idle guide portion 15 that holds the track of the rack belt 10 on the idle route R2. The frame 9 is made of a resin molded product, for example, in which the motor fixing portion 13, the guide rail fixing portion 14 and the idle guide portion 15 are integrally formed.

### Motor Fixing Portion 13 (Means to Fix and Support Drive Motor 4)

While having a plurality of irregularities in the direction Q as shown in FIG. 11A, the motor fixing portion 13 is formed as a plate-shaped portion along the plane substantially perpendicular to the direction Q. The motor fixing portion 13 has a plurality of nuts 16 fixed by a press-fit, an insert molding or the like, as well as a concave circular bearing portion 17 that rotatably supports a tip of an output shaft 4A of the drive motor 4. The motor fixing portion 13 and the nuts 16 arranged on the motor fixing portion 13 provide a means to fix and support the drive motor 4. The drive motor 4 is fastened and fixed to the motor fixing portion 13 by screwing bolts 18 into the nuts 16 in a state that the tip of the output shaft 4A is axle-supported by the bearing portion 17. With the tip of the output shaft 4A being axle-supported by the bearing portion 17, inclination of the drive gear 5 which is attached to the output shaft 4A can be prevented, thereby meshing the drive gear 5 with the rack teeth 10A of the rack belt 10 precisely.

When the drive motor 4 is fixed to the motor fixing portion 13, space around the driving gear 5 becomes the enclosed space 19 sealed by the housing of the drive motor 4 and the molded surface of the motor fixing portion 13 for the purpose of dustproof and waterproof. Further, the guide passage for guiding the rack belt 10 that moves between the guide rail fixing portion 14 and the idle guide portion 15 is formed appropriately on the motor fixing portion 13.

### Guide Rail Fixing Portion 14 (Means to Fix and Support Guide Rail 8)

The guide rail fixing portion 14 shown in FIG. 5 is a portion positioned at the top of the motor fixing portion 13, and formed as a vertical pass-through opening 20 in order to insert and fix the lower end of the guide rail 8 as shown in FIG. 10. The lower end of the opening 20 faces the enclosed space 19 (FIG. 11A). A plurality of fixing ribs 21 are protruded along the vertical direction on the inner wall constituting the opening 20, and the lower end of the guide rail 8 is fixed to the guide rail fixing portion 14 by being pressed with the fixing ribs 21. Specifically, the lower end of the guide rail 8 is positioned relative to the frame 9 in the direction P by the first frame surface 8A and the second frame surface 8B being pressed with the fixing ribs 21 at one line of place respectively, and positioned relative to the frame 9 in the direction Q by the first flange surface 8F and the second flange surface 8G being pressed with a pair of fixing ribs 21 respectively in a sandwiched manner.

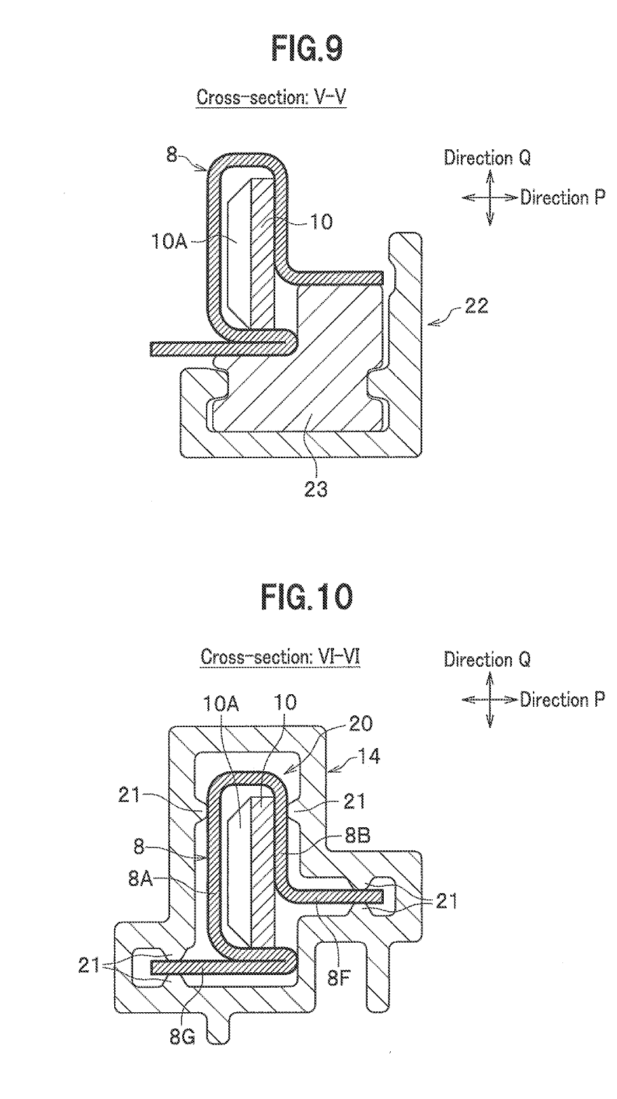

A stopper fixing portion 22 is formed above the opening 20 on the frame 9 as shown in FIGS. 5 and 9. A stopper 23 is mounted in the stopper fixing portion 22 in a manner that the stopper 23 is inserted from above. The stopper 23 is a rubber molded product, for example. The stopper 23 restricts the downward movement of the carrier 7 by coming into contact with the carrier 7. In addition, the stopper 23 assumes the dustproof and waterproof functions for the enclosed space 19 by closing a part of the gap between the inner wall of the opening 20 and the guide rail 8 from above (FIG. 11A).

### Idle Guide Portion 15 (Means for Holding Track of Elongate Push-Pull Member 6 in Idle Route R2)

In FIG. 5, the idle guide portion 15 is formed as a square pipe member having a rectangular cross-sectional shape that is longitudinal in the direction Q so as to guide the four sides of the rack belt 10 inserted therein. Facing the enclosed space 19 (FIG. 11A) at the tip side, the idle guide 15 is arranged in an aspect that the idle guide 15 extends downward from the bottom of the motor fixing portion 13, passes through: a curved portion 24 that is convex downward; a vertical portion 25 that extends upward substantially vertically; and an inclined linear portion 26 that becomes closer to the guide rail 8 as it extends higher, then bends inward and upward. A tail end 27 of the idle guide 15 is located above the meshing portion 41 between the drive gear 5 and the rack belt 10, and in the vicinity of the guide rail 8. Through holes 28 are formed on the sides, facing to the direction Q, of the idle guide portion 15 at appropriate intervals in the extending direction, for the purpose of weight reduction or the like. The curved portion 24, the vertical portion 25, the inclined linear portion 26 and the motor fixing portion 13 are connected with a connecting portion 29 for reinforcement. That is, the connecting portion 29 assumes the function to connect substantially the entire length of the idle guide portion 15 to the motor fixing portion 13.

Accordingly, vibration of the idle guide portion 15, which is an elongate material, is suppressed. The connecting portion 29 may be a plate-like body, a frame body or the like along the plane perpendicular to the direction Q, and especially a reinforced frame body having a honeycomb structure is preferable in terms of strength and light weight, as in the present embodiment.

### Mounting Holes 30 (Means for Attaching to Object)

A plurality of mounting holes 30 are formed around the motor fixing portion 13 of the frame 9, serving as a means for mounting the motor fixing portion 13 on the object (the side door 2). The window regulator 1 is fastened and fixed to the side door 2 (FIG. 1) with bolts through mounting holes 30 of the frame 9 at the lower portion, and fastened and fixed to the side door 2 with a bolt via the fixing bracket 11 (FIG. 4) at the upper portion, as described above.

### Operation

When the drive motor 4 is driven, the rack belt 10 meshing with the drive gear 5 moves in a straight line on the drive route R1 as viewed from the direction Q, and the carrier 7, which is engaged with the upper end of the rack belt 10 through the engaging projections 7H and the engaging holes 10B, moves up and down while being guided by the guide rail 8, and thereby the window glass 3 is lifted and lowered. The carrier 7 slides the guide rail 8, while the position relative to the guide rail 8 in the direction P is determined by contacting a back surface of the thin belt portion 10C of the rack belt 10 with the second frame surface 8B and contacting the resilient projections 71 protruded on the thin plate portion 7G1 with the first frame surface 8A, and the position relative to the guide rail 8 in the direction Q is determined by sandwiching the third frame surface 8C and the second flange surface 8G with the intermediate portion 7F and the sliding portion 7G of the belt connecting portion 7B and the one surface of the glass connecting portion 7A. The extra length of the belt rack 10, when the carrier 7 is lowered, is retracted and housed in a manner that is bended back upward by the idle guide portion 15.

Further, the first flange surface 8F assumes the function of receiving the intermediate portion 7F of the carrier 7, thereby preventing the tumbling of the carrier 7.

There is no need for adjusting the tension of the cable at the time of assembly, or the like, because of the structure using the open-ended rack belt 10 rather than in the form of an endless loop.

As the rack belt 10 moving in the guide rail 8 is laid out such that a surface having the rack teeth 10A faces toward the first frame surface 8A on which the opening 8E is not formed, that is, a surface having the rack teeth 10A is laid out inside the rectangular frame so as to face the opposite side from the opening 8E, ingress of dust or moisture toward the surface having the rack teeth 10A is reduced even if dust or moisture enters into the guide rail 8 from the opening 8E, thereby preventing the meshing portion 41 from catching the dust.

According to the present invention, since the drive route R1 for the elongate push-pull member 6 is formed in a straight line from the meshing portion 41 between the drive gear 5 and the elongate push-pull member 6 to the mounting portion of the carrier 7 (engaging portion 42), as viewed from the direction Q, that is, from a direction substantially perpendicular to the plate surface of the window glass 3, a curved portion no longer exists at the elongate push-pull member 6 on the drive route R1. Therefore, the bending stress does not occur and accordingly the transmission loss of the power of the elongate push-pull member 6 is reduced, and thereby the rotational force of the drive motor 4 is efficiently converted into linear movement force of the carrier and transmitted. On the other hand, as viewed from the direction Q, the elongate push-pull member 6, which is an elongate material, can be laid out compactly in the limited space such as the side door 2, by forming at least a part of the idle route R2, which retracts extra length of the elongate push-pull member from the meshing portion 41 to the other end of the elongate push-pull member, in a curved shape.

It is also possible to form the drive route R1 downward from the meshing portion 41 (such as using the window regulator 1 shown in FIG. 3 upside down without changing anything, for example) according to the present invention, however as the drive motor 4 is located at the upper side in this case, a structure that does not interfere with the drive motor 4 at the connecting portion between the carrier 7 and the window glass 3 is required, and further the position of the center of gravity of the window regulator 1 becomes high.

On the other hand, by forming the drive route R1 upward from the meshing portion 41 as in the present embodiment, the drive motor 4 is located at the lower portion of the window regulator 1, and thereby the connecting portion between the carrier 7 and the window glass 3 can be a simple structure while the position of the center of gravity of the window regulator 1 becomes low, thus providing the window regulator 1 that is suitable for the side door 2 of a vehicle requiring a low center of gravity.

Further, by providing the curved portion 24, which is convex downward, on the idle route R2 and positioning the tail end 27 of the idle route R2 above the meshing portion 41, the elongate push-pull member 6 can be more compactly retracted and housed by folding upward.

In addition, the guide rail 8 is provided with the rectangular frame portion (the first frame surface 8A, the second frame surface 8B, the third frame surface 8C, and the fourth frame surface 8D) which has the opening 8E for passing the carrier 7 (the belt coupling portion 7B) and constitutes a guide groove for the elongate push-pull member 6, and formed with the structure in which the engaging portion 42 between the elongate push-pull member 6 and the carrier 7 is laid out inside of the rectangular frame portion, therefore the structure of the engaging portion 42 becomes simple and compact, thereby saving space around the guide rail 8 in proportion to the extent that the engaging portion 42 does not move in the outside of the guide rail 8.

Further, the present invention includes the elongate push-pull member 6 that is composed of the rack belt 10, wherein the engaging portion 42 is constituted with the overlapping portion between the thin belt portion 10C of the rack belt 10, where the thin belt portion 10C is formed by cutting out a surface having the rack teeth 10A and formed with the engaging holes 10B, and the thin plate portion 7G1 of the career 7, where the thin plate portion 7G1 is formed with the engaging projections 7H, accompanied with the engagement between the engaging holes 10B and the engaging projections 7H, therefore the engaging portion 42 has a structure that is inexpensive and excellent in assembling.

A preferred embodiment of the present invention was described hereinabove. Although the elongate push-pull member 6 was the rack belt 10 in the described embodiment, a geared wire having a helical groove, which meshes with the drive gear 5 and helically formed around the outer periphery, may be another example of the elongate push-pull member 6. Of course, any open-ended belt other than the rack belt 10 can be used as the elongate push-pull member 6, and when a toothed pulley is used as the drive gear 5, for example, a timing belt having tooth grooves or tooth holes is used as the elongate push-pull member 6.

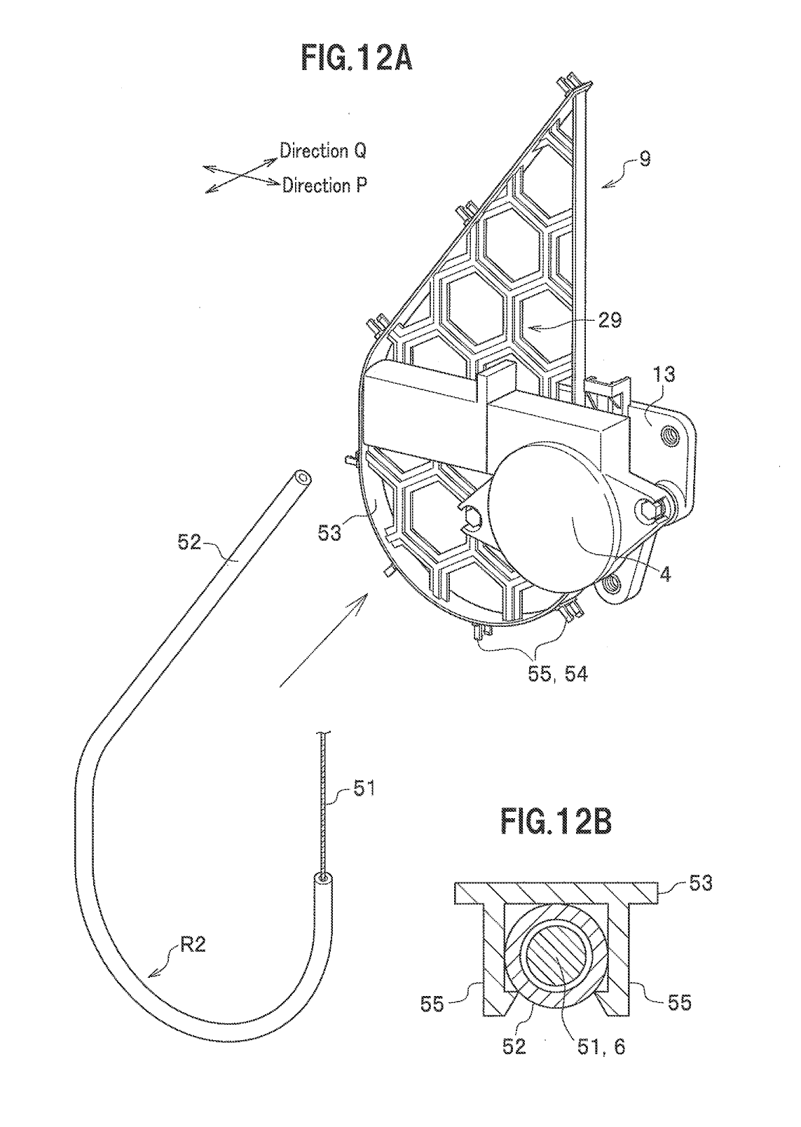

FIGS. 12A and 12B are explanatory diagrams showing an example of the “holding means of the track of the elongate push-pull member 6 on the idle route R2” when a geared wire 51 is used as the elongate push-pull member 6, where FIG. 12A is a perspective view and FIG. 12B is a cross-sectional view. The geared wire 51 is covered with a protective pipe 52 on the idle route R2. The protective pipe 52 is made of a plastic pipe, a metal pipe or the like. A mounting frame 53 is formed at the frame 9 along the track of the elongate push-pull member 6 on the idle route R2, and a plurality of protective-pipe fixing portions 54 are formed on the mounting frame 53 along the track. The protective pipe 52 is inserted into the lower side of the motor fixing portion 13 and fixed thereto, and fixed to the mounting frame 53 substantially over the entire length by the protective-pipe fixing portions 54. Each protective-pipe fixing portion 54 is composed of, for example, a pair of engagement claws 55 between which the protective pipe 52 is held, wherein the tip end portions of the claws elastically deform to allow passage of the protective pipe 52 when the protective pipe 52 is pressed onto the mounting frame 53, and afterwards the tip end portions of the claws elastically restore the original positions so as to engage the protective pipe 52 with the mounting frame 53 for fixation. In other words, the protective-pipe fixing portion 54 assumes a function to position the protective pipe 52. Thus, in an aspect provided with the protective pipe 52, the protective-pipe fixing portion 54 corresponds to the holding means of the track of the elongate push-pull member 6 on the idle route R2. Of course, the protective-pipe fixing portions 54 are also formed integrally with the frame 9.

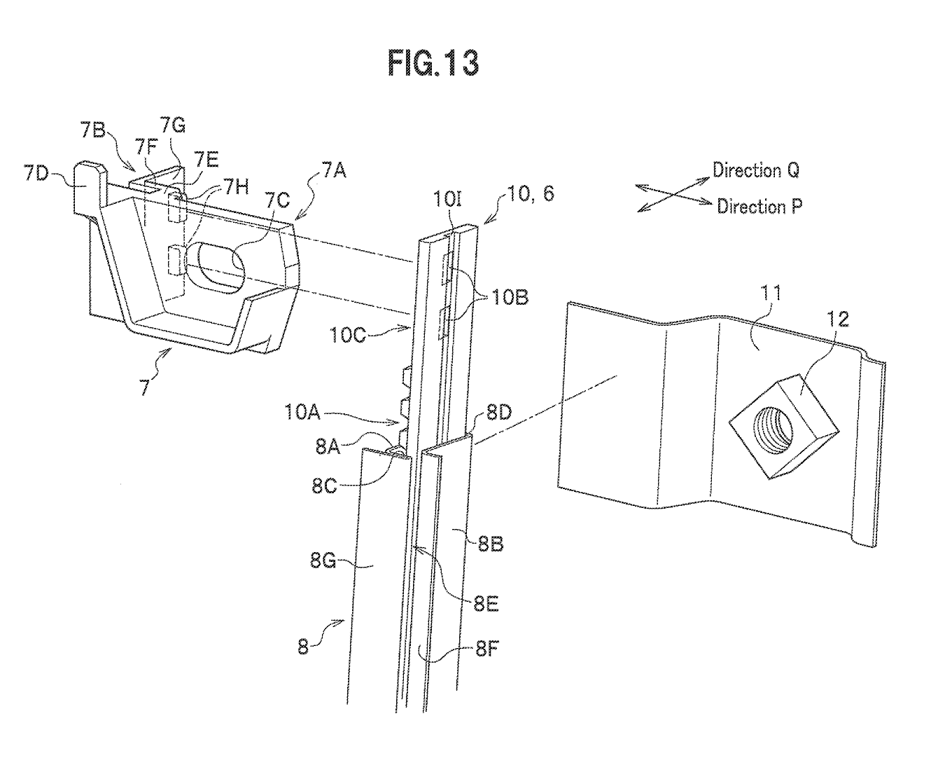

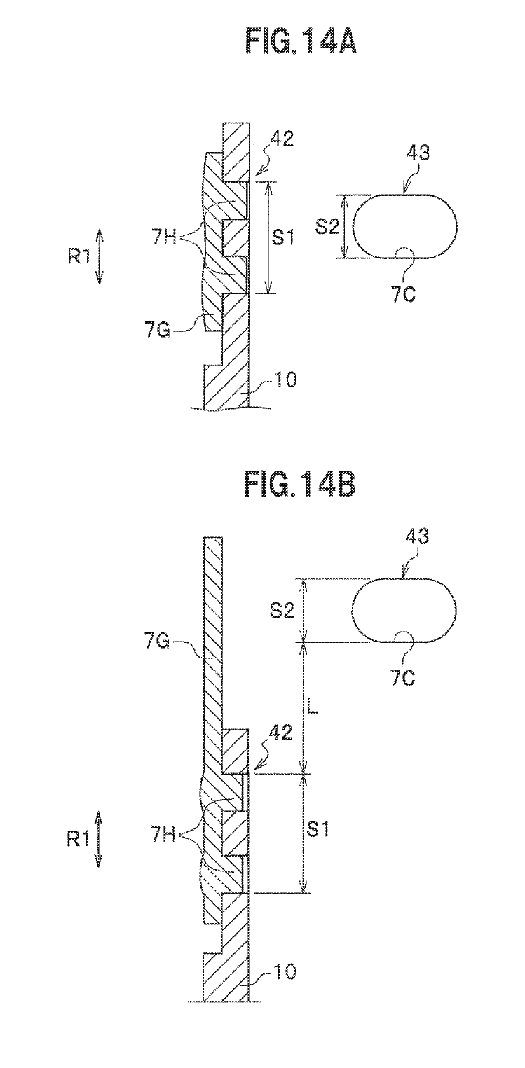

FIGS. 13 and 14A show an embodiment in which a forming range of the engaging portion 42 (reference numeral S1 in FIG. 14A) between the elongate push-pull member 6 and the carrier 7 is positioned to be overlapped with a forming range of the connecting portion 43 (reference numeral S2 in FIG. 14A) between the carrier 7 and the window glass 3 (FIG. 1) with respect to a direction along the drive route. The forming range S1 is a range from the top of the upper engaging projection 7H to the bottom of the lower engaging projection 7H. The forming range S2 is a range of from the top to the bottom of the mounting hole 7C constituting the connecting portion 43.

The shape of the carrier 7 is shown in FIG. 4 such that the thin plate portion 7G1 is extended below the lower edge of the glass connecting portion 7A and the engaging projections 7H as the engaging portion 42 are formed on the thin plate portion 7G1. As shown in FIG. 14B, the forming ranges S1 and S2 are spaced apart at a distance L in this shape without overlapping each other with respect to the direction along the drive route R1, thus there is a problem, when the forming ranges S1 and S2 are respectively assumed to be a point of effort and a point of action, that the rigidity of the carrier 7 is likely to decrease due to a tensile stress and a compressive stress generated between the two points. On the other hand, by forming the engaging projections 7H at the sliding portion 7G as shown in FIG. 13, and positioning the forming ranges S1 and S2 so as to be overlapped with each other as shown in FIG. 14A with respect to the direction along the drive route R1, the shape of the carrier 7 becomes compact as well as the occurrence of the stresses between the engaging portion 42 and the connecting portion 43 in the carrier 7 is reduced, thereby increasing the rigidity of the carrier 7. It should be noted that not only a case when the forming ranges S1 and S2 overlap completely as shown in FIG. 14A but also a case when a part of each of the forming ranges S1 and S2 overlap is encompassed within the scope of the present invention.

In addition, the rack belt 10 shown in FIG. 13 is formed with a rectangular groove 10I along the extending direction of the belt in the widthwise center of the back side of the belt. A pair of upper and lower engaging holes 10B faces the groove bottom of the rectangular groove 10I. When the engaging projections 7H of the carrier 7 engage with the engaging holes 10B, respectively, around the tip of the engaging projections 7H is made to stay within the rectangular groove 10I.

What is claimed is:

1. A window regulator comprising:
a drive gear that is attached to a drive motor;
an elongate push-pull member that is open-ended and pliable, meshes with the drive gear, and is push-pulled by the two-way rotation of the drive gear; and
a career that is connected to one end of the elongate push-pull member as well as a window glass,
wherein, as viewed from a direction substantially perpendicular to the plate surface of the window glass,
a drive route of the elongate push-pull member from an meshing portion between the drive gear and the elongate push-pull member to a mounting portion of the career is formed in a straight line,
while at least a part of an idle route for retracting an extra length of the elongate push-pull member from the meshing portion to the other end of the elongate member is formed in a curved shape.

2. The window regulator according to claim 1,
wherein the drive route is formed upward from the meshing portion,
while the idle route has a curved portion which is convex downward and an end of the idle route is positioned above the meshing portion.

3. The window regulator according to claim 1,
further comprising a guide rail that guides the elongate push-pull member and the carrier on the drive route,
wherein the guide rail comprises a rectangular frame portion, having an opening for inserting the carrier and constituting a guide groove for the elongate push-pull member, and
the engaging portion between the elongate push-pull member and the career is laid out inside the rectangular frame portion.

4. The window regulator according to claim 3,
wherein an elongate push-pull member is composed of a rack belt, and
an engaging portion between the rack belt and the carrier is constituted with an overlapping portion between a thin belt portion of the rack belt, where the thin belt portion is formed by cutting out a surface having the rack teeth and formed with engaging holes, and a thin plate portion of the career, where the thin plate portion is formed with engaging projections, accompanied with an engagement between the engaging holes and the engaging projections.

5. The window regulator according to claim 3,
wherein, with respect to a direction along the drive route, the forming range of the engaging portion is in a position overlapping with the forming range of a connecting portion between the carrier and the window glass.

6. The window regulator according to claim 3,
wherein the elongate push-pull member is composed of a rack belt that is laid out inside the rectangular frame portion so that a surface formed with the rack teeth faces the opposite side from the opening.
